(19) United States
(12) Patent Application Publication
(10) Pub. No.: US 2026/0369499 A1
(43) Pub. Date: Nov. 19, 2026

(54) RELAY UNIT

(71) Applicant: DENSO CORPORATION, Kariya-city (JP)

(72) Inventor: Tatsuki NISHIMATA, Kariya-city (JP)

(73) Assignee: DENSO CORPORATION, Kariya-city (JP)

(21) Appl. No.: 19/723,512

(22) Filed: Jun. 29, 2026

Related U.S. Application Data
(63) Continuation of application No. PCT/JP2024/045365, filed on Dec. 23, 2024.

(30) Foreign Application Priority Data
Jan. 9, 2024 (JP) 2024-001487

(51) Int. Cl. H01H 50/14; H01H 50/02

(52) U.S. Cl. CPC H01H 50/14; H01H 50/02

(57) ABSTRACT

A relay unit includes a positive electrode busbar, a negative electrode busbar, at least one electric component and a case. The at least one electric component is at least one of a positive electrode SMR, a negative electrode SMR, a positive electrode charging relay, a negative electrode charging relay, a precharge relay, a pyrotechnic fuse, a precharge resistor and an electric current sensor. Each of the relays is an electromagnetic relay which switches between conduction and interruption of an output electric current from a battery. The pyrotechnic fuse interrupts the output electric current from the battery. The precharge resistor forms an electrical resistance of the output electric current from the battery. The electric current sensor detects a magnitude of the output electric current from the battery. At least a portion of the at least one electric component is interposed between the positive electrode busbar and the negative electrode busbar.

### CROSS REFERENCE TO RELATED APPLICATIONS

This application is a continuation application of International Patent Application No. PCT/JP 2024/045365 filed on Dec. 23, 2024, which designated the U.S. and claims the benefit of priority from Japanese Patent Application No. 2024-001487 filed on Jan. 9, 2024. The entire disclosures of all of the above applications are incorporated herein by reference.

### TECHNICAL FIELD

The disclosure of this specification relates to a relay unit.

### BACKGROUND

A previously proposed relay unit is electrically connected between a battery and an inverter. This relay unit has a plurality of relays that are electromagnetic relays, a plurality of busbars and a plurality of connection terminals.

The connection terminals include: two battery terminals connected to a positive electrode and a negative electrode, respectively, of the battery; and two inverter terminals connected to a positive electrode and a negative electrode, respectively, of the inverter. The busbars include: a positive electrode busbar that forms an electric current path between one of the two battery terminals and one of the two inverter terminals; and a negative electrode busbar that forms an electric current path between the other one of the two battery terminals and the other one of the inverter terminals. The relays include: a positive electrode relay provided in the electric current path formed by the positive electrode busbar; and a negative electrode relay provided in the electric current path formed by the negative electrode busbar.

### SUMMARY

According to the present disclosure, there is provided a relay unit that may include a positive electrode busbar, a negative electrode busbar, at least one electric component and a case. The positive electrode busbar may form an electric current path between a positive electrode of a battery and an inverter. The negative electrode busbar may form an electric current path between a negative electrode of the battery and the inverter. The at least one electric component may be at least one of at least one relay, a fuse, a resistor and an electric current sensor. The at least one relay is an electromagnetic relay which may be configured to switch between conduction and interruption of an output electric current from the battery. The fuse may be configured to interrupt the output electric current. The resistor may be is configured to form an electrical resistance of the output electric current. The electric current sensor may be configured to detect a magnitude of the output electric current. The case may receive the positive electrode busbar, the negative electrode busbar and the at least one electric component. At least a portion of the at least one electric component may be interposed between the positive electrode busbar and the negative electrode busbar.

### BRIEF DESCRIPTION OF DRAWINGS

The drawings described herein are for illustrative purposes only of selected embodiments and not all possible implementations, and are not intended to limit the scope of the present disclosure.

FIG. 1 is a diagram showing an electrical configuration of a high voltage junction box according to a first embodiment of the present disclosure.

FIG. 2 is an exploded perspective view of the high voltage junction box according to the first embodiment.

FIG. 3 is a perspective view showing an internal structure of the high voltage junction box according to the first embodiment.

FIG. 4 is a top view showing the internal structure of the high voltage junction box according to the first embodiment.

FIG. 5 is a perspective view showing a connection structure between relays and busbars according to the first embodiment.

FIG. 6 is a perspective view showing a layout of the busbars according to the first embodiment.

### DETAILED DESCRIPTION

A previously proposed relay unit is electrically connected between a battery and an inverter. This relay unit has a plurality of relays that are electromagnetic relays, a plurality of busbars and a plurality of connection terminals.

The connection terminals include: two battery terminals connected to a positive electrode and a negative electrode, respectively, of the battery; and two inverter terminals connected to a positive electrode and a negative electrode, respectively, of the inverter. The busbars include: a positive electrode busbar that forms an electric current path between one of the two battery terminals and one of the two inverter terminals; and a negative electrode busbar that forms an electric current path between the other one of the two battery terminals and the other one of the inverter terminals. The relays include: a positive electrode relay provided in the electric current path formed by the positive electrode busbar; and a negative electrode relay provided in the electric current path formed by the negative electrode busbar.

In the previously proposed relay unit, each of the positive electrode busbar and the negative electrode busbar is shaped to connect the corresponding battery terminal and the corresponding inverter terminal by a shortest path. As a result, the positive electrode busbar and the negative electrode busbar are shaped to extend side by side with each other.

Here, when an external force such as a collision is applied to the relay unit, the busbars may deform. However, as described above, if the positive electrode busbar and the negative electrode busbar are shaped to extend adjacent to each other, there is a concern that they may contact each other and cause an electrical short circuit.

According to one aspect of the present disclosure, there is provided a relay unit including:
a positive electrode busbar that forms an electric current path between a positive electrode of a battery and an inverter;
a negative electrode busbar that forms an electric current path between a negative electrode of the battery and the inverter;
at least one electric component that is at least one of:
   at least one relay that is an electromagnetic relay which is configured to switch between conduction and interruption of an output electric current from the battery;
   a fuse that is configured to interrupt the output electric current;
   a resistor that is configured to form an electrical resistance of the output electric current; and
   an electric current sensor that is configured to detect a magnitude of the output electric current; and
a case that receives the positive electrode busbar, the negative electrode busbar and the at least one electric component, wherein:
at least a portion of the at least one electric component is interposed between the positive electrode busbar and the negative electrode busbar.

According to the above aspect, at least the portion of the at least one electric component is interposed between the positive electrode busbar and the negative electrode busbar. Therefore, even when at least one of the two busbars is deformed due to, for example, an impact, the at least one electric component functions as a cushioning material between the two busbars. Thus, it is possible to reduce the risk that the two busbars contact each other to cause a short circuit. Furthermore, since the electric components are interposed between the two busbars, the distance between the two busbars is increased by an installation space for the electric components. Thus, it is possible to reduce the risk that the two busbars contact each other to cause a short circuit.

Hereinafter, a plurality of embodiments will be described with reference to the drawings. In the following respective embodiments, corresponding structural elements are indicated by the same reference signs and may not be redundantly described. When only a part of the configuration is described in each embodiment, the configuration of the other embodiments described previously can be applied to the other parts of the configuration. Furthermore, not only combinations of configurations explicitly stated in the descriptions of the respective embodiments, but also configurations of the embodiments can be partially combined even if not explicitly stated, unless there is a particular problem with the combination.

### First Embodiment

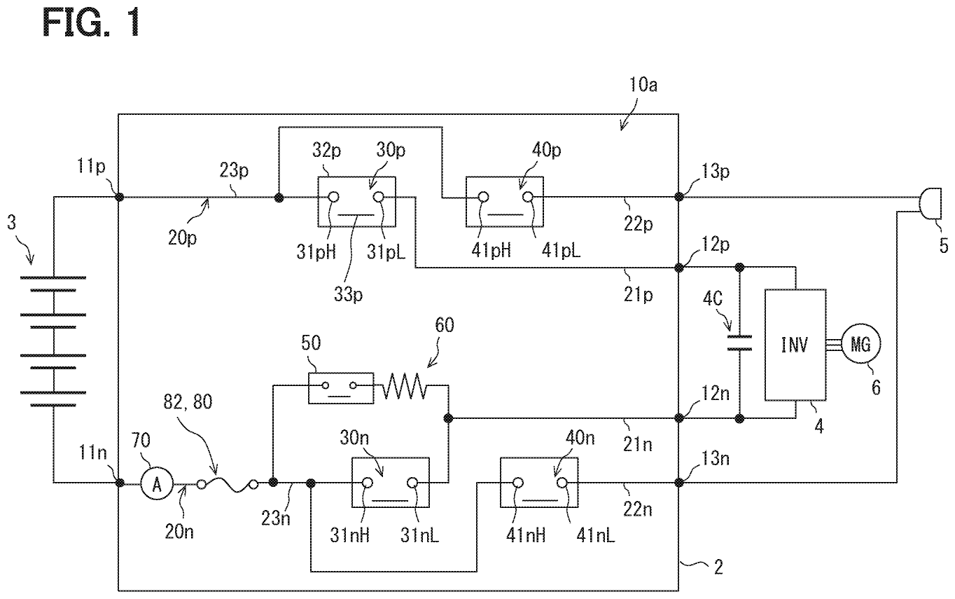

A high-voltage junction box (hereinafter, high-voltage JB) according to a first embodiment of the present disclosure shown in FIG. 1 is used in an electric vehicle such as a BEV (Battery Electric Vehicle) or other types of electric vehicles. The high-voltage JB 2 is mounted on the electric vehicle together with a battery 3, an inverter 4 and a charging inlet 5. The high-voltage JB 2 is electrically connected to the battery 3, the inverter 4 and the charging inlet 5.

The battery 3 is an electric power storage device that stores electric power for causing the electric vehicle to travel. The battery 3 is configured to include a chargeable/dischargeable secondary battery such as a lithium-ion battery or a nickel-metal hydride battery. The inverter 4 is electrically connected to a motor generator 6 for driving the vehicle. The motor generator 6 is a permanent magnet type or wound-field type synchronous motor, an induction motor or the like.

The inverter 4 controls a rotational speed and a torque of the motor generator 6. A smoothing capacitor 4C is connected in parallel to the inverter 4. The smoothing capacitor 4C smooths the electric current supplied from the battery 3 to the inverter 4 through the high-voltage JB 2. A charging cable of a charging station provided outside the vehicle is connected to the charging inlet 5. Direct current (DC) power for rapidly charging the battery 3 is applied to the charging inlet 5. The charging inlet 5 supplies the DC power supplied from the charging station to the high-voltage JB 2.

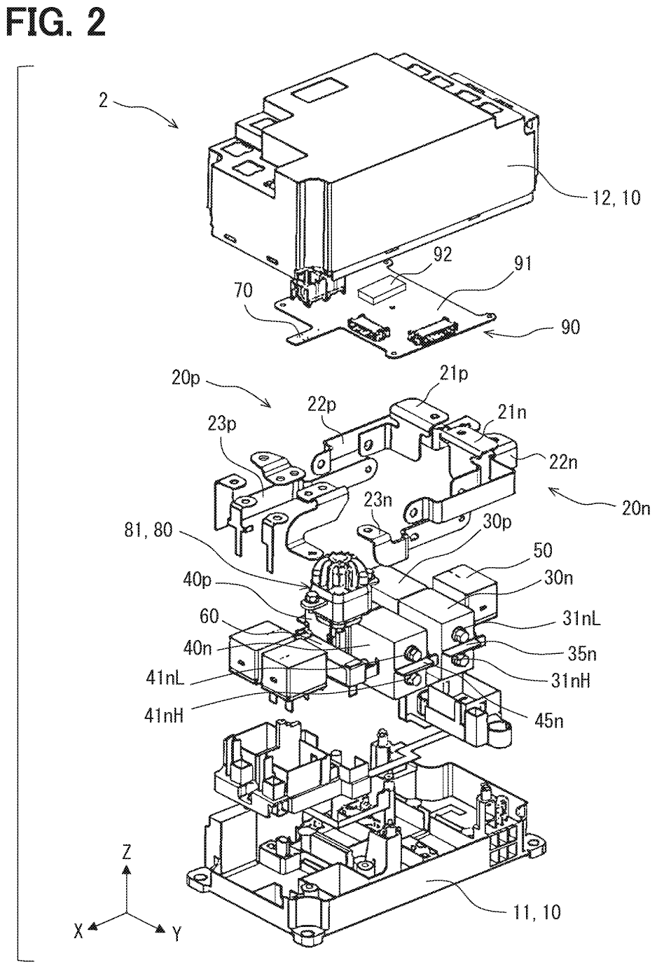

The high-voltage JB 2 includes a power control circuit 10a and a JB case 10 (see FIG. 2) that protects the power control circuit 10a. The power control circuit 10a includes a plurality of electric current paths. The power control circuit 10a is configured to switch among the plurality of electric current paths.

The power control circuit 10a includes a pair of battery terminals (hereinafter, BAT terminals) 11p, 11n, a pair of inverter terminals (hereinafter, INV terminals) 12p, 12n and a pair of charging terminals 13p, 13n. An element with “p” attached to a reference sign represents a structure on the positive electrode side. An element with “n” attached to a reference sign represents a structure on the negative electrode side (ground side).

The BAT terminals 11p, 11n are terminals that are used for electrical connection between the high-voltage JB 2 and the battery 3. The BAT terminal 11p is connected to a positive electrode of the battery 3. The BAT terminal 11n is connected to a negative electrode of the battery 3. The INV terminals 12p, 12n are terminals that are used for electrical connection between the high-voltage JB 2 and the inverter 4. The INV terminal 12p is connected to a positive electrode of the inverter 4. The INV terminal 12n is connected to a negative electrode of the inverter 4.

The charging terminals 13p, 13n are terminals that are used for electrical connection between the high-voltage JB 2 and the charging inlet 5. The charging terminal 13p is connected to a positive electrode of the charging inlet 5. The charging terminal 13n is connected to a negative electrode of the charging inlet 5. Electric power for charging the battery 3 is supplied to the charging terminals 13p, 13n.

Furthermore, the power control circuit 10a includes a positive electrode busbar 20p, a negative electrode busbar 20n, a positive electrode system main relay (hereinafter, positive electrode SMR) 30p, a negative electrode system main relay (hereinafter, negative electrode SMR) 30n, a positive electrode charging relay 40p and a negative electrode charging relay 40n. Furthermore, the power control circuit 10a includes a precharge relay 50, a precharge resistor 60, an electric current sensor 70 and a pyrotechnic fuse 80.

### Busbars

As shown in FIG. 1, the positive electrode busbar 20p forms an electric current path between the positive electrode of the battery 3 and the inverter 4. The negative electrode busbar 20n forms an electric current path between the negative electrode of the battery 3 and the inverter 4. The positive electrode busbar 20p and the negative electrode busbar 20n are conductive members, respectively, each of which has a plate shape and is made of, for example, a metal material that is excellent in conductivity such as copper. These busbars are capable of carrying a large current sufficient to cause the motor generator 6 to generate a driving force for traveling the vehicle, and these busbars form a plurality of current paths of the power control circuit 10a.

The positive electrode busbar 20p includes a positive electrode inverter busbar (hereinafter, positive electrode INV busbar) 21p, a positive electrode charging busbar 22p and a positive electrode battery busbar (hereinafter, positive electrode BAT busbar) 23p. That is, these busbars are electrically connected to each other such that each of these busbars forms a portion of the electric current path formed by the positive electrode busbar 20p. The negative electrode busbar 20n includes a negative electrode inverter busbar (hereinafter, negative electrode INV busbar) 21n, a negative electrode charging busbar 22n and a negative electrode battery busbar (hereinafter, negative electrode BAT busbar) 23n.

The positive electrode INV busbar 21p forms an electric current path between the inverter 4 and the positive electrode SMR 30p. Specifically, one end of the positive electrode INV busbar 21p is connected to the INV terminal 12p, and the other end of the positive electrode INV busbar 21p is connected to the positive electrode SMR 30p. The negative electrode INV busbar 21n forms an electric current path between the inverter 4 and the negative electrode SMR 30n. Specifically, one end of the negative electrode INV busbar 21n is connected to the INV terminal 12n, and the other end of the negative electrode INV busbar 21n is connected to the negative electrode SMR 30n.

The positive electrode charging busbar 22p forms an electric current path between the charging inlet 5 and the positive electrode charging relay 40p. Specifically, one end of the positive electrode charging busbar 22p is connected to the charging terminal 13p, and the other end of the positive electrode charging busbar 22p is connected to the positive electrode charging relay 40p. The negative electrode charging busbar 22n forms an electric current path between the charging inlet 5 and the negative electrode charging relay 40n. Specifically, one end of the negative electrode charging busbar 22n is connected to the charging terminal 13n, and the other end of the negative electrode charging busbar 22n is connected to the negative electrode charging relay 40n.

The positive electrode BAT busbar 23p forms an electric current path between the battery 3 and the positive electrode SMR 30p. Specifically, one end of the positive electrode BAT busbar 23p is connected to the BAT terminal 11p, and the other end of the positive electrode BAT busbar 23p is connected to the positive electrode SMR 30p. The negative electrode BAT busbar 23n forms an electric current path between the battery 3 and the negative electrode SMR 30n. Specifically, one end of the negative electrode BAT busbar 23n is connected to the BAT terminal 11n, and the other end of the negative electrode BAT busbar 23n is connected to the negative electrode SMR 30n.

### Relays

The positive electrode SMR 30p corresponds to a “positive electrode relay” and is positioned between the positive electrode BAT busbar 23p and the positive electrode INV busbar 21p. The negative electrode SMR 30n corresponds to a “negative electrode relay” and is positioned between the negative electrode BAT busbar 23n and the negative electrode INV busbar 21n. The precharge relay 50 is connected in parallel to the negative electrode SMR 30n. The positive electrode SMR 30p, the negative electrode SMR 30n and the precharge relay 50 switch a state of the electric current path between the battery 3 and the inverter 4 between a conducting state (ON) and a non-conducting state (OFF).

The positive electrode charging relay 40p is positioned between the positive electrode SMR 30p and the positive electrode charging busbar 22p. The positive electrode charging relay 40p is connected in parallel to the positive electrode SMR 30p. The negative electrode charging relay 40n is positioned between the negative electrode SMR 30n and the negative electrode charging busbar 22n. The negative electrode charging relay 40n is connected in parallel to the negative electrode SMR 30n. The positive electrode charging relay 40p and the negative electrode charging relay 40n switch a state of the electric current path between the battery 3 and the charging inlet 5 between a conducting state (ON) and a non-conducting state (OFF).

Respective operations of the positive electrode SMR 30p, the negative electrode SMR 30n, the precharge relay 50, the positive electrode charging relay 40p and the negative electrode charging relay 40n are individually controlled by a controller device 90 (see FIG. 2) mounted on the vehicle. The controller device 90 includes an arithmetic processing circuit including a processor, a RAM (Random Access Memory), a storage and the like. For example, the controller device 90 includes a control circuit board 91 and a microcomputer 92. The microcomputer 92 provides the processor, the RAM and the storage. The arithmetic processing circuit is provided by the control circuit board 91, the microcomputer 92 and various electronic components mounted on the control circuit board 91.

The arithmetic processing circuit, which is formed by the controller device 90, outputs a control signal for controlling switching between ON and OFF to each of the various relays described above. In short, in accordance with the control signal received from the controller device 90, these various relays switch the plurality of electric current paths including the various busbars described above, which conduct a large direct current of several tens to several hundreds of amperes.

The various relays described above all have the same structure and the same specifications, and hereinafter, the structure of the relay will be described by taking the positive electrode SMR 30p as an example. The positive electrode SMR 30p includes a stationary core, a movable core, a rod, an excitation coil, an urging spring, a movable terminal 33p (see FIG. 1), a pair of stationary terminals 31pH, 31pL and a relay case 32p. The stationary core, the movable core, the rod, the excitation coil, the urging spring, the movable terminal and the pair of stationary terminals 31pH, 31pL are received in the relay case 32p. A part of each of the stationary terminals 31pH, 31pL is exposed from the relay case 32p and is connected to the positive electrode busbar 20p described above.

When the excitation coil is excited by the control signal outputted from the controller device 90, the movable core is attracted to the stationary core and is operated. The rod is coupled to the movable core, and the movable terminal is coupled to the rod. The movable terminal, which is moved in response to the operation of the movable core, abuts against the pair of stationary terminals 31pH, 31pL. As a result, the pair of stationary terminals 31pH, 31pL are electrically connected by the movable terminal and are brought into a conducting state (ON). When the output of the control signal is stopped and the excitation coil is no longer excited, the movable core is pushed back to an original position, which is a position before the excitation, by the urging spring, and the movable terminal is separated from the pair of stationary terminals 31pH, 31pL. As a result, the pair of stationary terminals 31pH, 31pL are brought into a non-conducting state (OFF).

Among the pair of stationary terminals 31pH, 31pL of the positive electrode SMR 30p, the stationary terminal 31pH is a high-voltage terminal (i.e., a terminal on the high-voltage side), and the stationary terminal 31pL is a low-voltage terminal (i.e., a terminal on the low-voltage side). An element with “H” attached to a reference sign has a configuration on the high voltage side. An element with “L” attached to a reference sign has a configuration on the low voltage side.

In the present embodiment, the pair of stationary terminals 31pH, 31pL received in the relay case 32p of the positive electrode SMR 30p correspond to “positive electrode terminals”. A pair of stationary terminals 31nH, 31nL received in a relay case 32n of the negative electrode SMR 30n correspond to “negative electrode terminals”. A pair of stationary terminals 41pH, 41pL received in a relay case 42p of the positive electrode charging relay 40p correspond to “positive electrode charging terminals”. A pair of stationary terminals 41nH, 41nL received in a relay case 42n of the negative electrode charging relay 40n respectively correspond to “negative electrode charging terminals”. As shown in FIG. 1, the positive electrode terminals and the positive electrode charging terminals are connected to the positive electrode busbar 20p. The negative electrode terminals and the negative electrode charging terminals are connected to the negative electrode busbar 20n.

The connection relationship between the busbars and the relays will be described in more detail below with reference to FIGS. 2 to 6. The stationary terminal 31pH of the positive electrode SMR 30p is connected to a connection 23p1 of the positive electrode BAT busbar 23p. The stationary terminal 31pL is connected to a connection 21p1 of the positive electrode INV busbar 21p. The stationary terminal 41pH of the positive electrode charging relay 40p is connected to a connection 23p2 of the positive electrode BAT busbar 23p. The stationary terminal 41pL is connected to a connection 22p1 of the positive electrode charging busbar 22p.

The stationary terminal 31nH of the negative electrode SMR 30n is connected to a connection 23n1 of the negative electrode BAT busbar 23n. The stationary terminal 31nL is connected to a connection 21n1 of the negative electrode INV busbar 21n. The stationary terminal 41nH of the negative electrode charging relay 40n is connected to a connection 23n2 of the negative electrode BAT busbar 23n. The stationary terminal 41nL is connected to a connection 22n1 of the negative electrode charging busbar 22n.

In the present embodiment, bolts are used for connection between the terminals of the various relays and the busbars. However, the connection is not limited to the bolts and may be connected by, for example, crimping, riveting, pressure bonding or welding.

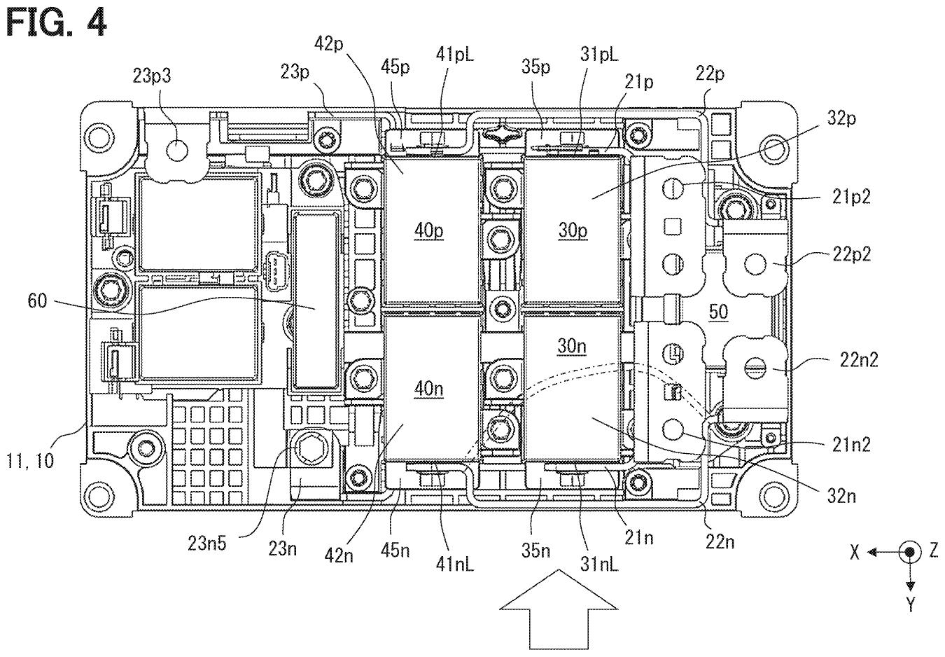

As shown in FIG. 4, a positive electrode insulating plate 35p is provided at the relay case 32p of the positive electrode SMR 30p. The positive electrode insulating plate 35p is made of resin having an electrical insulation property and is resin-molded integrally with the relay case 32p. The positive electrode insulating plate 35p is disposed between the pair of stationary terminals 31pL, 31pH. The positive electrode insulating plate 35p has a plate shape and is disposed so as to separate the pair of stationary terminals 31pL, 31pH from each other.

As shown in FIGS. 4 and 2, a negative electrode insulating plate 35n is provided at the relay case 32n of the negative electrode SMR 30n. The negative electrode insulating plate 35n is made of resin having an electrical insulation property and is resin-molded integrally with the relay case 32n. The negative electrode insulating plate 35n is disposed between the pair of stationary terminals 31nL, 31nH. The negative electrode insulating plate 35n has a plate shape and is disposed so as to separate the pair of stationary terminals 31nL, 31nH from each other.

As shown in FIG. 4, a positive electrode insulating plate 45p is provided at the relay case 42p of the positive electrode charging relay 40p. The positive electrode insulating plate 45p is made of resin having an electrical insulation property and is resin-molded integrally with the relay case 42p. The positive electrode insulating plate 45p is disposed between the pair of stationary terminals 41pL, 41pH. The positive electrode insulating plate 45p has a plate shape and is disposed so as to separate the pair of stationary terminals 41pL, 41pH from each other.

As shown in FIGS. 4 and 2, a negative electrode insulating plate 45n is provided at the relay case 42n of the negative electrode charging relay 40n. The negative electrode insulating plate 45n is made of resin having an electrical insulation property and is resin-molded integrally with the relay case 42n. The negative electrode insulating plate 45n is disposed between the pair of stationary terminals 41nL, 41nH. The negative electrode insulating plate 45n has a plate shape and is disposed so as to separate the pair of stationary terminals 41nL, 41nH from each other.

The precharge resistor 60 is connected in series with the precharge relay 50. The precharge resistor 60 and the precharge relay 50 form an electric current path that is formed between the negative electrode BAT busbar 23n and the negative electrode INV busbar 21n and bypasses the negative electrode SMR 30n. The precharge resistor 60 reduces a charging electric current (inrush current), which flows to the smoothing capacitor 4C when the precharge relay 50 is switched to the conducting state (ON).

For example, when the positive electrode SMR 30p and the negative electrode SMR 30n are turned on in a state where the amount of charge accumulated in the smoothing capacitor 4C is small, there is a concern that the inrush current described above may occur, causing damage to equipment. Therefore, when the amount of charge in the smoothing capacitor 4C is small, such as at startup, the precharge relay 50 is turned on prior to turning on of the positive electrode SMR 30p and the negative electrode SMR 30n. Thereby, the amount of charge in the smoothing capacitor 4C can be increased through the electric current path via the precharge resistor 60. Thereafter, the positive electrode SMR 30p and the negative electrode SMR 30n are turned on to supply electric power to the inverter 4 without passing through the precharge resistor 60.

The electric current sensor 70 is provided on the negative electrode BAT busbar 23n and detects a magnitude of an electric current (output electric current) outputted from the battery 3. The electric current sensor 70 has a magnetic core and a Hall element (not shown). The magnetic core is formed in a ring shape and is arranged to surround the negative electrode BAT busbar 23n, which is a measurement target. The Hall element detects a magnetic flux generated in the magnetic core by an electric current flowing through the negative electrode BAT busbar 23n. The electric current sensor 70 measures the electric current flowing through the negative electrode BAT busbar 23n by detecting a change in an output voltage of the Hall element.

The pyrotechnic fuse 80 is provided on the negative electrode BAT busbar 23n and functions as a current interrupter. The pyrotechnic fuse 80 is automatically disconnected when an abnormally large electric current is generated in the negative electrode BAT busbar 23n. By interrupting the connection with the battery 3, the pyrotechnic fuse 80 protects other structures of the power control circuit 10a and the inverter 4 from an overcurrent. The pyrotechnic fuse 80 has an igniter 81, a piston (not shown) and a severable busbar 82.

For example, when a current value detected by the electric current sensor 70 exceeds a predetermined threshold value, the microcomputer 92 outputs an ignition current to the igniter 81. The igniter 81, to which the ignition current is supplied, burns and generates a gas. The piston is pushed down by a pressure of the gas generated in the igniter 81 to cut the severable busbar 82. The severable busbar 82 is connected to the negative electrode BAT busbar 23n so as to constitute a part of the electric current path formed by the negative electrode BAT busbar 23n. Therefore, when the severable busbar 82 is cut by the piston as described above, the electric current path of the negative electrode BAT busbar 23n is interrupted. Thereby, when an abnormally large electric current is generated, the electric current path of the negative electrode busbar 20n is interrupted.

### Positional Relationship of Components

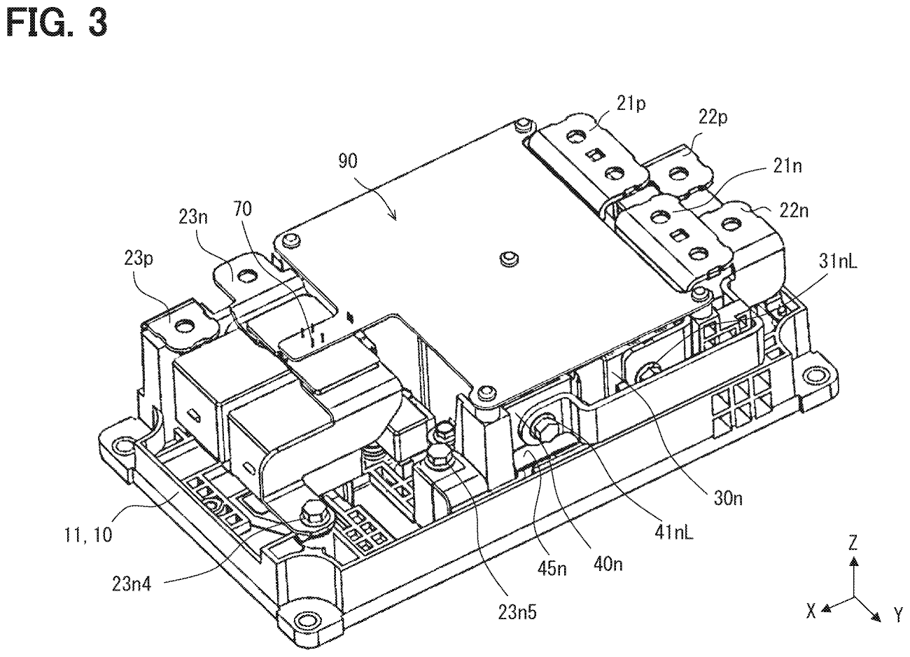

The high-voltage JB 2 corresponds to a “relay unit”. The positive electrode SMR 30p, the negative electrode SMR 30n, the positive electrode charging relay 40p, the negative electrode charging relay 40n, the precharge relay 50, the pyrotechnic fuse 80, the precharge resistor 60 and the electric current sensor 70 correspond to “electric components”. These electric components are received in the JB case 10. The JB case 10 has a base plate 11 made of resin and a cover 12 made of resin. Each of the electric components is fixed to the base plate 11 by screws or the like. FIGS. 3 and 4 show the high-voltage JB 2 in a state where the cover 12 is removed from the base plate 11.

As shown in FIG. 4, the positive electrode SMR 30p and the positive electrode charging relay 40p are arranged adjacent to each other along a first direction (X direction) which is predetermined. The positive electrode SMR 30p and the negative electrode SMR 30n are arranged adjacent to each other along a second direction (Y direction) which is predetermined and is perpendicular to the first direction. A Z direction indicated by an arrow in the drawing is a direction perpendicular to the X direction and the Y direction. An up-down direction in a state where the high-voltage JB 2 is mounted on the vehicle coincides with the Z direction. The positive electrode SMR 30p and the positive electrode charging relay 40p are arranged at the same position in the Z direction.

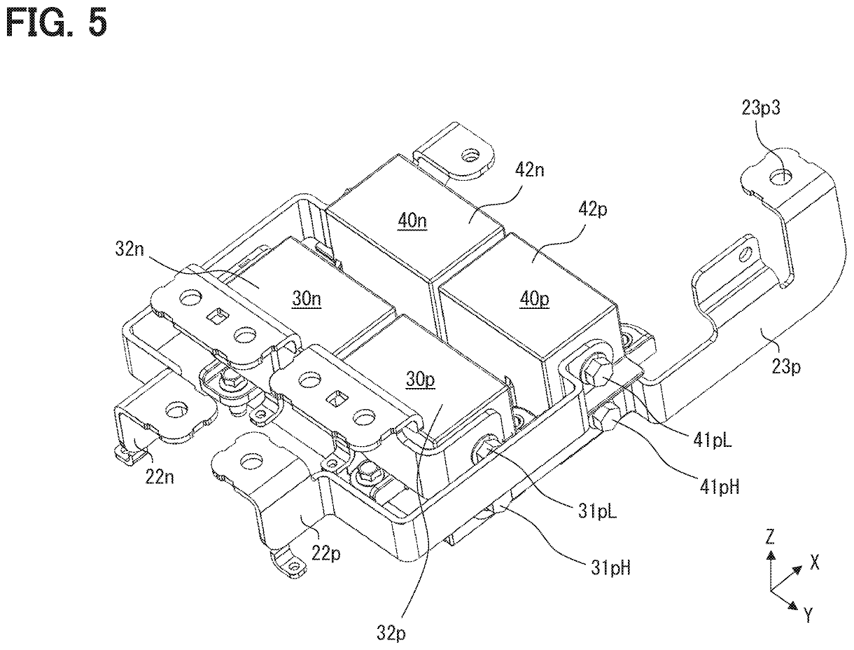

As shown in FIG. 5, the stationary terminal 31pL of the positive electrode SMR 30p and the stationary terminal 41pL of the positive electrode charging relay 40p are arranged adjacent to each other along the X direction. These stationary terminals 31pL, 41pL are arranged at the same position in the Y direction and the Z direction. The stationary terminal 31pH of the positive electrode SMR 30p and the stationary terminal 41pH of the positive electrode charging relay 40p are arranged adjacent to each other along the X direction. These stationary terminals 31pH, 41pH are arranged at the same position in the Y direction and the Z direction.

As shown in FIG. 4, the negative electrode SMR 30n and the negative electrode charging relay 40n are arranged adjacent to each other along the first direction (X direction). As shown in FIG. 2, the stationary terminal 31nL of the negative electrode SMR 30n and the stationary terminal 41nL of the negative electrode charging relay 40n are arranged adjacent to each other along the X direction. These stationary terminals 31nL, 41nL are arranged at the same position in the Y direction and the Z direction. The stationary terminal 31nH of the negative electrode SMR 30n and the stationary terminal 41nH of the negative electrode charging relay 40n are arranged adjacent to each other along the X direction. These stationary terminals 31nH, 41nH are arranged at the same position in the Y direction and the Z direction.

In other words, the positive electrode SMR 30p is attached to the base plate 11 such that the pair of stationary terminals 31pL, 31pH of the positive electrode SMR 30p are arranged along the Z direction. The negative electrode SMR 30n is attached to the base plate 11 such that the pair of stationary terminals 31nL, 31nH of the negative electrode SMR 30n are arranged along the Z direction. Furthermore, the positive electrode charging relay 40p is attached to the base plate 11 such that the pair of stationary terminals 41pL, 41pH of the positive electrode charging relay 40p are arranged along the Z direction. The negative electrode charging relay 40n is attached to the base plate 11 such that the pair of stationary terminals 41nL, 41nH of the negative electrode charging relay 40n are arranged along the Z direction.

Furthermore, the positive electrode SMR 30p and the negative electrode SMR 30n are attached to the base plate 11 such that the stationary terminals 31pL, 31pH of the positive electrode SMR 30p and the stationary terminals 31nL, 31nH of the negative electrode SMR 30n face away from each other. That is, the stationary terminals 31pL, 31pH face away from the negative electrode SMR 30n in the Y direction. The stationary terminals 31nL, 31nH face away from the positive electrode SMR 30p in the Y direction.

Furthermore, the positive electrode charging relay 40p and the negative electrode charging relay 40n are attached to the base plate 11 such that the stationary terminals 41pL, 41pH of the positive electrode charging relay 40p and the stationary terminals 41nL, 41nH of the negative electrode charging relay 40n face away from each other. That is, the stationary terminals 41pL, 41pH face away from the negative electrode charging relay 40n in the Y direction. The stationary terminals 41nL, 41nH face away from the positive electrode charging relay 40p in the Y direction.

The positive electrode SMR 30p, the negative electrode SMR 30n, the positive electrode charging relay 40p and the negative electrode charging relay 40n are arranged between the positive electrode busbar 20p and the negative electrode busbar 20n. The precharge relay 50, the pyrotechnic fuse 80, the precharge resistor 60 and the electric current sensor 70 are similarly arranged between the positive electrode busbar 20p and the negative electrode busbar 20n. Hereinafter, these arrangements will be described in more detail.

### Wall Surface Facing Portions

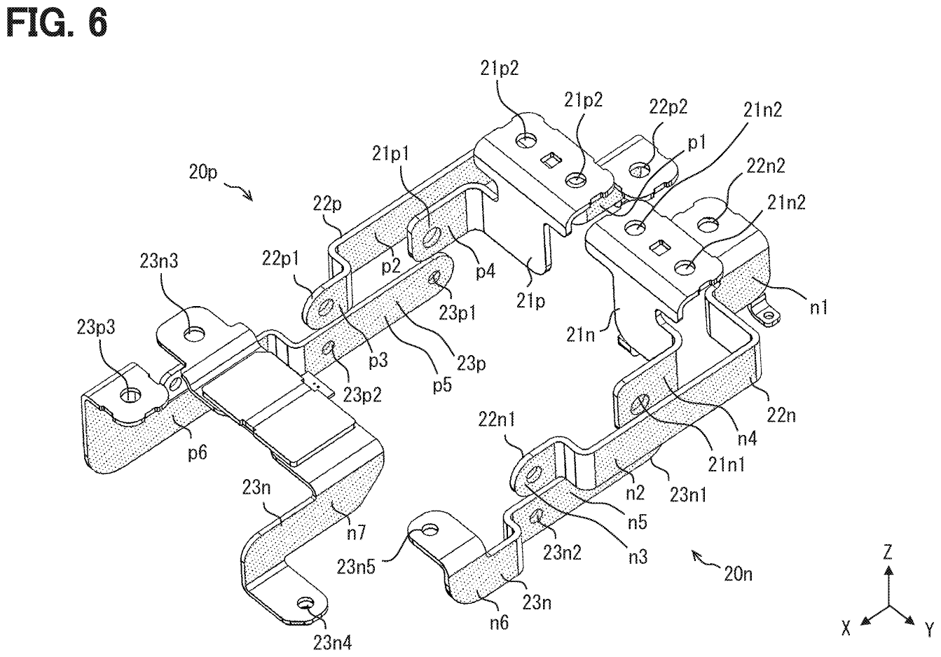

As shown in FIG. 6, the positive electrode busbar 20p includes a plurality of positive electrode wall surface facing portions p1 to p6. The negative electrode busbar 20n includes a plurality of negative electrode wall surface facing portions n1 to n7. Portions marked with halftone dots in FIG. 6 correspond to the positive electrode wall surface facing portions p1 to p6 and the negative electrode wall surface facing portions n1 to n7. These wall surface facing portions are portions of plate surfaces of the busbars facing a wall surface of the case 10. The plate surfaces of the wall surface facing portions are parallel to the plate surface of the case 10, which extends in a plane perpendicularly to the Y direction. The positive electrode SMR 30p, the negative electrode SMR 30n, the positive electrode charging relay 40p and the negative electrode charging relay 40n are arranged between the positive electrode wall surface facing portions p1 to p6 and the negative electrode wall surface facing portions n1 to n7.

The positive electrode charging busbar 22p has the positive electrode wall surface facing portions p1, p2, p3, and the negative electrode charging busbar 22n has the negative electrode wall surface facing portions n1, n2, n3. The positive electrode INV busbar 21p has the positive electrode wall surface facing portion p4, and the negative electrode INV busbar 21n has the negative electrode wall surface facing portion n4. The positive electrode BAT busbar 23p has the positive electrode wall surface facing portions p5, p6, and the negative electrode BAT busbar 23n has the negative electrode wall surface facing portions n5, n6, n7.

The positive electrode charging relay 40p and the negative electrode charging relay 40n are interposed between: the positive electrode wall surface facing portions p2, p3, p5; and the negative electrode wall surface facing portions n2, n3, n5. The positive electrode SMR 30p and the negative electrode SMR 30n are interposed between: the positive electrode wall surface facing portions p2, p4, p5; and the negative electrode wall surface facing portions n2, n4, n5.

The precharge relay 50 is interposed between the positive electrode wall surface facing portion p1 and the negative electrode wall surface facing portion n1. The pyrotechnic fuse 80 is interposed between the positive electrode wall surface facing portion p6 and the negative electrode wall surface facing portion n7. The precharge resistor 60 is interposed between the positive electrode wall surface facing portion p6 and the negative electrode wall surface facing portion n6. The electric current sensor 70 is interposed between the positive electrode wall surface facing portion p6 and the negative electrode wall surface facing portion n7.

Note that the phrase “the electric components are arranged between the positive electrode busbar 20p and the negative electrode busbar 20n” described above means that at least a portion of the electric component is positioned in a region between the positive electrode busbar 20p and the negative electrode busbar 20n. The “region between the positive electrode busbar 20p and the negative electrode busbar 20n” refers to a region corresponding to an overlap obtained by projecting the positive electrode busbar 20p onto the negative electrode busbar 20n, or by projecting the negative electrode busbar 20n onto the positive electrode busbar 20p. Furthermore, a portion of one electric component may be positioned in the region described above, or the entirety of the one electric component may be positioned in the region described above.

### Summary of First Embodiment

Here, an external force may be applied to the high-voltage JB 2 when, for example, the vehicle on which the high-voltage JB 2 is mounted is involved in a collision. For example, when an external force is applied in a direction indicated by a hollow arrow in FIG. 4, the negative electrode charging busbar 22n deforms toward the inside of the JB case 10 as indicated by a dot-dash line. Therefore, if the positive electrode busbar 20p and the negative electrode busbar 20n are shaped so as to extend side by side, there is a concern that the positive electrode busbar 20p and the negative electrode busbar 20n may contact each other and cause an electrical short circuit.

In view of this concern, in the present embodiment, at least a portion of the electric component is interposed between the positive electrode busbar 20p and the negative electrode busbar 20n. Therefore, even when at least one of the positive electrode busbar 20p and the negative electrode busbar 20n is deformed by an external force such as an impact, the electric components function as a cushioning material between the two busbars. Thus, the risk that the two busbars may contact each other and cause a short circuit can be reduced. Furthermore, since the electric components are interposed between the two busbars, the distance between the two busbars is increased by an installation space for the electric components. Thus, it is possible to reduce the risk that the two busbars contact each other to cause a short circuit.

Furthermore, in the present embodiment, both the positive electrode SMR 30p and the negative electrode SMR 30n are interposed between the positive electrode busbar 20p and the negative electrode busbar 20n. Thus, the function of the SMRs (electric components) as the cushioning material between the two busbars can be improved.

Furthermore, in the present embodiment, the positive electrode SMR 30p and the negative electrode SMR 30n are arranged such that the stationary terminals 31pH, 31pL (positive electrode terminals) and the stationary terminals 31nH, 31nL (negative electrode terminals) face away from each other. According to this, the positive electrode terminals and the negative electrode terminals are positioned away from each other. As a result, a portion of the positive electrode busbar 20p connected to the positive electrode terminals and a portion of the negative electrode busbar 20n connected to the negative electrode terminals are positioned away from each other. Thus, when the busbars are deformed by an external force, the risk that the two busbars contact each other to cause a short circuit can be further reduced.

Furthermore, in the present embodiment, the positive electrode SMR 30p has the positive electrode insulating plate 35p arranged between the pair of stationary terminals 31pL, 31pH (positive electrode terminals). Therefore, even when the busbar is deformed by an external force, the risk that a portion of the positive electrode busbar 20p connected to the stationary terminal 31pL and a portion of the positive electrode busbar 20p connected to the stationary terminal 31pH contact each other and cause a short circuit can be reduced. Thus, it is possible to reduce the risk that the positive electrode SMR 30p unintentionally enters a conducting state.

Furthermore, in the present embodiment, the negative electrode SMR 30n includes the negative electrode insulating plate 35n that is interposed between the pair of stationary terminals 31nL, 31nH (negative electrode terminals). Therefore, even when the busbar is deformed by an external force, the risk that a portion of the negative electrode busbar 20n connected to the stationary terminal 31nL and a portion of the negative electrode busbar 20n connected to the stationary terminal 31nH contact each other and cause a short circuit can be reduced. Thus, it is possible to reduce a risk that the negative electrode SMR 30n unintentionally enters a conducting state.

Furthermore, in the present embodiment, both the positive electrode charging relay 40p and the negative electrode charging relay 40n are interposed between the positive electrode busbar 20p and the negative electrode busbar 20n. Thus, the function of the charging relays (electric components) as the cushioning material between the two busbars can be improved.

Furthermore, in the present embodiment, the positive electrode charging relay 40p and the negative electrode charging relay 40n are arranged such that the stationary terminals 41pH, 41pL (positive electrode charging terminals) and the stationary terminals 41nH, 41nL (negative electrode charging terminals) face away from each other. According to this, the positive electrode charging terminals and the negative electrode charging terminals are positioned away from each other. As a result, a portion of the positive electrode busbar 20p connected to the positive electrode charging terminals and a portion of the negative electrode busbar 20n connected to the negative electrode charging terminals are positioned away from each other. Thus, when at least one of the positive electrode busbar 20p and the negative electrode busbar 20n is deformed by an external force, the risk that the two busbars may contact each other and cause a short circuit can be further reduced.

Furthermore, in the present embodiment, the stationary terminal 31pH (i.e., the high-voltage terminal among the pair of positive electrode terminals) of the positive electrode SMR 30p and the stationary terminal 41pH (i.e., the high-voltage terminal among the pair of positive electrode charging terminals) of the positive electrode charging relay 40p are arranged along the first direction (X direction). Also, the stationary terminal 31pL (i.e., the low-voltage terminal among the pair of positive electrode terminals) of the positive electrode SMR 30p and the stationary terminal 41pL (i.e., the low-voltage terminal among the pair of positive electrode charging terminals) of the positive electrode charging relay 40p are arranged along the first direction. Therefore, when the positive electrode busbar 20p connects the terminals arranged along the first direction, the positive electrode busbar 20p has a larger portion extending along the first direction.

Furthermore, the stationary terminal 31nH (i.e., the high-voltage terminal among the pair of negative electrode terminals) of the negative electrode SMR 30n and the stationary terminal 41nH (i.e., the high-voltage terminal among the pair of negative electrode charging terminals) of the negative electrode charging relay 40n are arranged along the first direction. The stationary terminal 31nL (i.e., the low-voltage terminal among the pair of negative electrode terminals) of the negative electrode SMR 30n and the stationary terminal 41nL (i.e., the low-voltage terminal among the pair of negative electrode charging terminals) of the negative electrode charging relay 40n are arranged along the first direction. Therefore, when the negative electrode busbar 20n connects the terminals arranged along the first direction, the negative electrode busbar 20n has a larger portion extending along the first direction.

In short, according to the arrangement of the stationary terminals described above, both the positive electrode busbar 20p and the negative electrode busbar 20n have the larger portion extending along the first direction. That is, a region interposed between the two busbars can be efficiently enlarged. Therefore, while adopting a layout in which the lengths of the two busbars are shortened, it is possible to easily interpose the electric components between the positive electrode busbar 20p and the negative electrode busbar 20n. Moreover, since it becomes easier to achieve the concentrated arrangement of the plurality of electric components interposed between the two busbars in a space-saving manner, the high-voltage JB 2 can also be downsized.

Here, since the positive electrode busbar 20p and the negative electrode busbar 20n conduct a large electric current, they generate heat due to electric current conduction. As a result, there are concerns about disadvantages such as thermal damage to the electronic components including the microcomputer 92, and an increase in electrical resistance. In view of this point, in the present embodiment, the positive electrode busbar 20p has the positive electrode wall surface facing portions p1, p2, p3, p4, p5, p6 which are portions facing the wall surface of the case 10. The negative electrode busbar 20n has the negative electrode wall surface facing portions n1, n2, n3, n4, n5, n6, n7 which are portions facing the wall surface of the case 10. The electric components are interposed at least between the positive electrode wall surface facing portions and the negative electrode wall surface facing portions. Therefore, it is possible to promote the dissipation of the heat of the busbars from the wall surface facing portions to the case 10. The case 10 can be expected to be cooled by the outside air. As described above, the above concerns can be reduced.

### Other Embodiments

Although the embodiment according to the present disclosure has been described above, the present disclosure is not construed as being limited to the above embodiment and can be applied to various embodiments and combinations without departing from the gist of the present disclosure.

In the above embodiment, the positive electrode charging relay 40p is connected in parallel to the positive electrode SMR 30p. However, the positive electrode charging relay 40p may be connected in series to the positive electrode SMR 30p. In the above embodiment, the negative electrode charging relay 40n is connected in parallel to the negative electrode SMR 30n. However, the negative electrode charging relay 40n may be connected in series to the negative electrode SMR 30n.

In the above embodiment, the electric components are interposed between the positive electrode busbar 20p and the negative electrode busbar 20n. The electric components include all of the positive electrode SMR 30p, the negative electrode SMR 30n, the positive electrode charging relay 40p, the negative electrode charging relay 40n, the precharge relay 50, the pyrotechnic fuse 80, the precharge resistor 60 and the electric current sensor 70. In contrast, it is sufficient that at least one of these electric components is interposed between the positive electrode busbar 20p and the negative electrode busbar 20n.

In the above embodiment, both the positive electrode SMR 30p and the negative electrode SMR 30n are interposed between the positive electrode busbar 20p and the negative electrode busbar 20n. However, it is possible to adopt a layout in which either one of the positive electrode SMR 30p and the negative electrode SMR 30n is interposed between the positive electrode busbar 20p and the negative electrode busbar 20n. Furthermore, in the above embodiment, both the positive electrode charging relay 40p and the negative electrode charging relay 40n are interposed between the positive electrode busbar 20p and the negative electrode busbar 20n. However, it is possible to adopt a layout in which either one of the positive electrode charging relay 40p and the negative electrode charging relay 40n is interposed between the positive electrode busbar 20p and the negative electrode busbar 20n.

In the above embodiment, the positive electrode SMR 30p and the negative electrode SMR 30n are arranged along the same direction (Y direction) as the direction along which the positive electrode busbar 20p and the negative electrode busbar 20n are arranged. In contrast, the positive electrode SMR 30p and the negative electrode SMR 30n may be arranged along the X direction or may be arranged along the Z direction. Furthermore, in the above embodiment, the positive electrode charging relay 40p and the negative electrode charging relay 40n are arranged along the same direction (Y direction) as the direction along which the positive electrode busbar 20p and the negative electrode busbar 20n are arranged. In contrast, the positive electrode charging relay 40p and the negative electrode charging relay 40n may be arranged along the X direction or may be arranged along the Z direction.

In the above embodiment, the positive electrode SMR 30p and the positive electrode charging relay 40p are arranged along the same direction (X direction) as the longitudinal direction in which the positive electrode wall surface facing portions p1 to p6 of the positive electrode busbar 20p extend. In contrast, the positive electrode SMR 30p and the positive electrode charging relay 40p may be arranged along the Y direction or may be arranged along the Z direction. Furthermore, in the above embodiment, the negative electrode SMR 30n and the negative electrode charging relay 40n are arranged along the same direction (X direction) as the longitudinal direction in which the negative electrode wall surface facing portions n1 to n7 of the negative electrode busbar 20n extend. In contrast, the negative electrode SMR 30n and the negative electrode charging relay 40n may be arranged along the Y direction or may be arranged along the Z direction.

In the above embodiment, there is described the example in which the relay unit of the present disclosure is applied to the high-voltage JB 2 mounted on the electric vehicle. However, the relay unit can also be applied to various applications different from the electric vehicle. For example, the relay unit according to the present disclosure may be mounted on various moving bodies such as railway vehicles, trams, drones and electric aircraft such as eVTOLs.

### Disclosure of Technical Ideas

This specification discloses a plurality of technical ideas described in a plurality of clauses listed below. Some clauses may be described in a multiple dependent form that alternatively cites preceding clauses in subsequent clauses. Furthermore, some clauses may be described in a multiple dependent form referring to another multiple dependent form. Clauses described in these multiple dependent forms define a plurality of technical ideas.

What is claimed is:

1. A relay unit comprising:
a positive electrode busbar that forms an electric current path between a positive electrode of a battery and an inverter;
a negative electrode busbar that forms an electric current path between a negative electrode of the battery and the inverter;
a plurality of electric components that at least include a plurality of relays each of which is an electromagnetic relay that is configured to switch between conduction and interruption of an output electric current from the battery or a charging electric current to the battery; and
a case that receives the positive electrode busbar, the negative electrode busbar and the plurality of electric components, wherein:
the plurality of relays include a plurality of charging relays, each of which is configured to switch between the conduction and the interruption of the charging electric current flowing between the battery and a charging inlet;
the plurality of charging relays include:
a positive electrode charging relay which has a pair of positive electrode charging terminals connected to the positive electrode busbar; and
a negative electrode charging relay which has a pair of negative electrode charging terminals connected to the negative electrode busbar; and
at least a portion of the positive electrode charging relay and at least a portion of the negative electrode charging relay are interposed between the positive electrode busbar and the negative electrode busbar.

2. The relay unit according to claim 1, wherein:
the plurality of relays includes:
a positive electrode relay that has a pair of positive electrode terminals connected to the positive electrode busbar and is configured to switch between the conduction and the interruption of the output electric current; and
a negative electrode relay that has a pair of negative electrode terminals connected to the negative electrode busbar and is configured to switch between the conduction and the interruption of the output electric current; and
the positive electrode relay and the negative electrode relay are both interposed between the positive electrode busbar and the negative electrode busbar.

3. The relay unit according to claim 2, wherein the positive electrode relay and the negative electrode relay are arranged such that the pair of positive electrode terminals and the pair of negative electrode terminals face away from each other.

4. The relay unit according to claim 2, wherein:
the positive electrode relay has a positive electrode insulating plate which is a member having an electrical insulation property and is disposed between the pair of positive electrode terminals; and
the negative electrode relay has a negative electrode insulating plate which is a member having an electrical insulation property and is disposed between the pair of negative electrode terminals.

5. The relay unit according to claim 1, wherein the positive electrode charging relay and the negative electrode charging relay are arranged such that the pair of positive electrode charging terminals and the pair of negative electrode charging terminals face away from each other.

6. The relay unit according to claim 3, wherein:
the positive electrode charging relay and the negative electrode charging relay are arranged such that the pair of positive electrode charging terminals and the pair of negative electrode charging terminals face away from each other;
the positive electrode busbar includes:
a positive electrode inverter busbar which forms an electric current path between the inverter and the positive electrode relay;
a positive electrode charging busbar which forms an electric current path between the charging inlet and the positive electrode charging relay; and
a positive electrode battery busbar which forms an electric current path between the battery and the positive electrode relay;
the negative electrode busbar includes:
a negative electrode inverter busbar which forms an electric current path between the inverter and the negative electrode relay;
a negative electrode charging busbar which forms an electric current path between the charging inlet and the negative electrode charging relay; and
a negative electrode battery busbar which forms an electric current path between the battery and the negative electrode relay;
the positive electrode relay and the positive electrode charging relay are arranged along a first direction which is predetermined;
the negative electrode relay and the negative electrode charging relay are arranged along the first direction;
a high-voltage terminal among the pair of positive electrode terminals and a high-voltage terminal among the pair of positive electrode charging terminals are arranged along the first direction;
a low-voltage terminal among the pair of positive electrode terminals and a low-voltage terminal among the pair of positive electrode charging terminals are arranged along the first direction;
a high-voltage terminal among the pair of negative electrode terminals and a high-voltage terminal among the pair of negative electrode charging terminals are arranged along the first direction; and
a low-voltage terminal among the pair of negative electrode terminals and a low-voltage terminal among the pair of negative electrode charging terminals are arranged along the first direction.

7. The relay unit according to claim 1, wherein:
the positive electrode busbar has at least one positive electrode wall surface facing portion which faces a wall surface of the case;
the negative electrode busbar has at least one negative electrode wall surface facing portion which faces another wall surface of the case; and
at least one of the plurality of electric components is interposed at least between the at least one positive electrode wall surface facing portion and the at least one negative electrode wall surface facing portion.

8. A relay unit comprising:
a positive electrode busbar that forms an electric current path between a positive electrode of a battery and an inverter;
a negative electrode busbar that forms an electric current path between a negative electrode of the battery and the inverter;
a plurality of electric components that at least include a plurality of relays each of which is an electromagnetic relay that is configured to switch between conduction and interruption of an output electric current from the battery or a charging electric current to the battery; and
a case that receives the positive electrode busbar, the negative electrode busbar and the plurality of electric components, wherein:
the plurality of relays include:
a positive electrode relay that has a pair of positive electrode terminals connected to the positive electrode busbar and is configured to switch between the conduction and the interruption of the output electric current;
a negative electrode relay that has a pair of negative electrode terminals connected to the negative electrode busbar and is configured to switch between the conduction and the interruption of the output electric current; and
a plurality of charging relays, each of which is configured to switch between the conduction and the interruption of the charging electric current flowing between the battery and a charging inlet;
the positive electrode relay and the negative electrode relay are arranged such that the pair of positive electrode terminals and the pair of negative electrode terminals face away from each other;
at least a portion of the positive electrode relay and at least a portion of the negative electrode relay are interposed between the positive electrode busbar and the negative electrode busbar;
the plurality of charging relays include:
a positive electrode charging relay which has a pair of positive electrode charging terminals connected to the positive electrode busbar; and
a negative electrode charging relay which has a pair of negative electrode charging terminals connected to the negative electrode busbar;
the positive electrode charging relay and the negative electrode charging relay are arranged such that the pair of positive electrode charging terminals and the pair of negative electrode charging terminals face away from each other;
the positive electrode busbar includes:
a positive electrode inverter busbar which forms an electric current path between the inverter and the positive electrode relay;
a positive electrode charging busbar which forms an electric current path between the charging inlet and the positive electrode charging relay; and
a positive electrode battery busbar which forms an electric current path between the battery and the positive electrode relay;
the negative electrode busbar includes:
a negative electrode inverter busbar which forms an electric current path between the inverter and the negative electrode relay;
a negative electrode charging busbar which forms an electric current path between the charging inlet and the negative electrode charging relay; and
a negative electrode battery busbar which forms an electric current path between the battery and the negative electrode relay;
the positive electrode relay and the positive electrode charging relay are arranged along a first direction which is predetermined;
the negative electrode relay and the negative electrode charging relay are arranged along the first direction;
a high-voltage terminal among the pair of positive electrode terminals and a high-voltage terminal among the pair of positive electrode charging terminals are arranged along the first direction;
a low-voltage terminal among the pair of positive electrode terminals and a low-voltage terminal among the pair of positive electrode charging terminals are arranged along the first direction;
a high-voltage terminal among the pair of negative electrode terminals and a high-voltage terminal among the pair of negative electrode charging terminals are arranged along the first direction; and
a low-voltage terminal among the pair of negative electrode terminals and a low-voltage terminal among the pair of negative electrode charging terminals are arranged along the first direction.

9. The relay unit according to claim 8, wherein:
the positive electrode busbar has at least one positive electrode wall surface facing portion which faces a wall surface of the case;
the negative electrode busbar has at least one negative electrode wall surface facing portion which faces another wall surface of the case; and
at least one of the plurality of electric components is interposed at least between the at least one positive electrode wall surface facing portion and the at least one negative electrode wall surface facing portion.
